(19) United States
(12) Patent Application Publication
(10) Pub. No.: US 2018/0144374 A1
(43) Pub. Date: May 24, 2018

(54) INFORMATION PROCESSING SYSTEM THAT DISPLAYS ADVERTISEMENT CORRESPONDING TO CONTENT OF PROCESSING TARGET, AND INFORMATION PROCESSING METHOD

(71) Applicant: KYOCERA DOCUMENT SOLUTIONS INC., Osaka (JP)

(72) Inventor: SHINICHIRO WATASE, OSAKA (JP)

(21) Appl. No.: 15/818,970

(22) Filed: Nov. 21, 2017

(30) Foreign Application Priority Data
Nov. 24, 2016 (JP) 2016-227785

(51) Int. Cl. G06Q 30/02; H04N 1/10; G06K 9/18; G06K 9/46

(52) U.S. Cl. CPC G06Q 30/0275; H04N 1/10; H04L 67/10; G06K 9/4604; G06K 9/18

(57) ABSTRACT

An information processing system includes: information processing apparatuses; and a head office server, the information processing apparatuses each including an OCR processing unit that executes an OCR process on image data, and extracts character data, one or more bidding scripts each participating in competitive bidding, the one or more bidding scripts each analyzing the character data, selecting, on the basis of an analysis result, an advertisement, and presenting an advertisement fee for the selected advertisement, and an advertisement selection unit that selects, on the basis of a result of the competitive bidding, a bidding script that has presented a highest advertisement fee, causes a display device to display an advertisement to be displayed selected by the selected bidding script, and stores selection result information in a storage unit, the selection result information including a result of the selection and the advertisement fee that the selected bidding script has presented.

### CROSS REFERENCE TO RELATED APPLICATION

This application claims the benefit of Japanese Priority Patent Application JP 2016-227785 filed Nov. 24, 2016, the entire contents of which are incorporated herein by reference.

### BACKGROUND OF THE INVENTION

### 1. Field of the Invention

The present disclosure relates to an information processing system and an information processing method that display an advertisement corresponding to the content of a processing target.

### 2. Description of Related Art

With respect to a recent electronic advertisement, particularly, Internet advertisement, technological advances are remarkable in terms of both software and hardware, and a big industry is already established.

It is desirable to provide an information processing system and an information processing method that can display an advertisement corresponding to the content of a processing target.

### SUMMARY OF THE INVENTION

An information processing system according to an embodiment of the present disclosure includes: information processing apparatuses installed in one or more shop sites; and a head office server connected to each of the information processing apparatuses via a network, the head office server being installed in a head office site, each of the information processing apparatuses including a communication device configured to communicate with the head office server, an operation device, a display device, a storage device that stores one or more advertisements that can be displayed on the display device, an image scanner that reads a script and generates image data, a ROM that stores an information processing program, and a processor that executes the information processing program, in which the processor executes the information processing program to function as an OCR processing unit that executes an OCR process on the image data generated by the image scanner, and extracts character data, one or more bidding scripts that (i) analyze the character data transmitted from the OCR processing unit, (ii) select, on the basis of an analysis result, an advertisement to be displayed on the display device from the one or more advertisements, and (iii) present an advertisement fee for the selected advertisement to participate in competitive bidding, and an advertisement selection unit that (i) selects, on the basis of a result of the competitive bidding, a bidding script that has presented a highest advertisement fee, (ii) causes the display device to display an advertisement to be displayed selected by the selected bidding script, and (iii) stores selection result information in the storage unit, the selection result information including a result of the selection and the advertisement fee that the selected bidding script has presented.

An information processing method according to an embodiment of the present disclosure is an information processing method for an information processing system including information processing apparatuses installed in one or more shop sites and a head office server connected to each of the information processing apparatuses via a network, the head office server being installed in a head office site, the method including: reading, by an image scanner of each of the information processing apparatuses, a script, and generating, by the image scanner, image data; executing, by an OCR processing unit of each of the information processing apparatuses, an OCR process on the image data generated by the image scanner, and extracting, by the OCR processing unit, character data; analyzing, by one or more bidding scripts of each of the information processing apparatuses, the character data transmitted from the OCR processing unit, selecting, by the one or more bidding scripts, on the basis of an analysis result, an advertisement to be displayed on the display device from one or more advertisements, presenting, by the one or more bidding scripts, an advertisement fee for the selected advertisement, and participating, by the one or more bidding scripts, in competitive bidding; and selecting, by an advertisement selection unit of each of the information processing apparatuses, on the basis of a result of the competitive bidding, a bidding script that has presented a highest advertisement fee, causing, by the advertisement selection unit, the display device to display an advertisement to be displayed selected by the selected bidding script, and storing, by the advertisement selection unit, selection result information in the storage unit, the selection result information including a result of the selection and the advertisement fee that the selected bidding script has presented.

These and other objects, features and advantages of the present disclosure will become more apparent in light of the following detailed description of best mode embodiments thereof, as illustrated in the accompanying drawings.

### BRIEF DESCRIPTION OF THE DRAWINGS

FIG. 1 shows a configuration of an information processing system 1 according to an embodiment of the present disclosure;

FIG. 2 schematically shows a block configuration of an image forming apparatus 20;

FIG. 3 shows flow of data in an information processing system 1;

FIG. 4 shows an example of competitive bidding performed by a plurality of bidding scripts 21c;

FIG. 5 shows an example of the bidding scripts 21c for performing competitive bidding, which are provided by advertisers;

FIG. 6 shows flowchart of a process executed each time a user causes the image forming apparatus 20 to read a script among processes executed by the information processing system 1; and

FIG. 7 shows flowchart of a process of a part relating to a process of charging an advertisement fee to the advertiser among the processes executed by the information processing system 1.

### DETAILED DESCRIPTION OF THE PREFERRED EMBODIMENTS

Hereinafter, an embodiment of the present disclosure will be described with reference to the drawings. Note that in the following, an image forming apparatus will be described as an example of an information processing apparatus installed in each shop site in an information processing system according to an embodiment of the present disclosure.

[Entire Configuration]

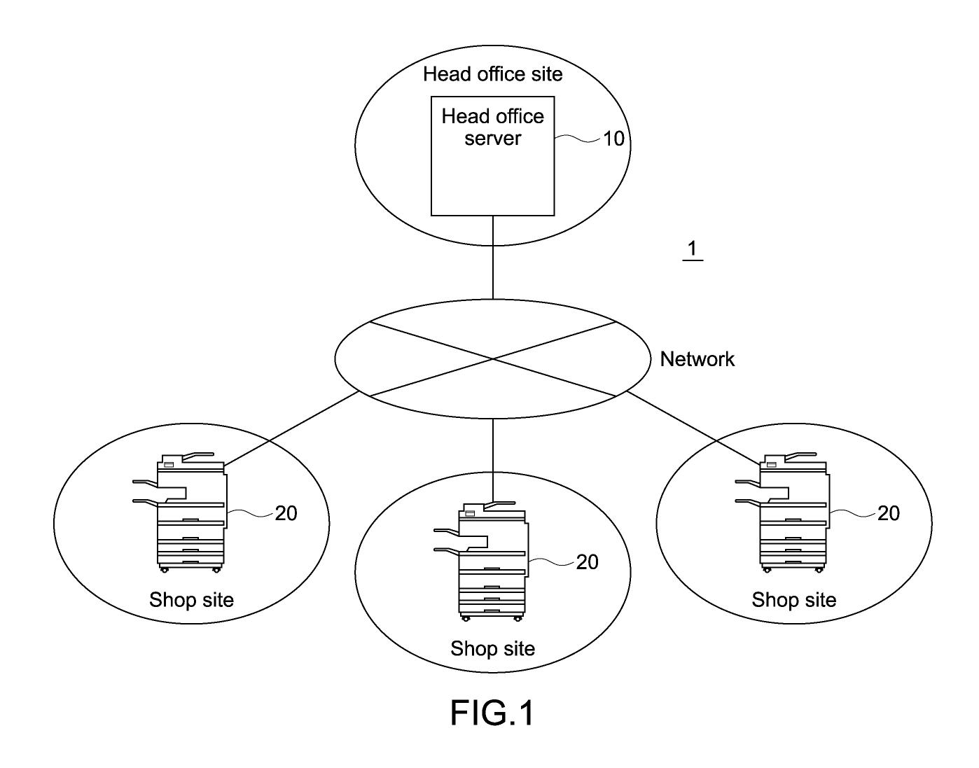

A configuration of an information processing system 1 according to an embodiment of the present disclosure will be described first. FIG. 1 shows the configuration of the information processing system 1 according to an embodiment of the present disclosure.

The information processing system 1 includes a head office server 10 installed in a head office site, and an image forming apparatus 20 installed in each shop site. The head office server 10 and each image forming apparatus 20 are connected to each other via a network.

The head office server 10 is used for summing up advertisement fees of advertisements displayed on each of the image forming apparatuses 20 and charging a summed advertisement fee to each of the advertisers.

Each image forming apparatus 20 displays an advertisement on a display device on an operation panel, corresponding to the content of a script copied by a user.

Note that the point to be noted with the above-mentioned configuration is that the head office server 10 is used for executing a process of collectively charging advertisement fees to advertisers, and is not related at all to selection and display of an advertisement. A process of selecting an advertisement and a process of displaying an advertisement are independently executed by each image forming apparatus 20.

The configuration of the information processing system 1 according to an embodiment of the present disclosure has been described heretofore.

[Configuration of Image Forming Apparatus 20]

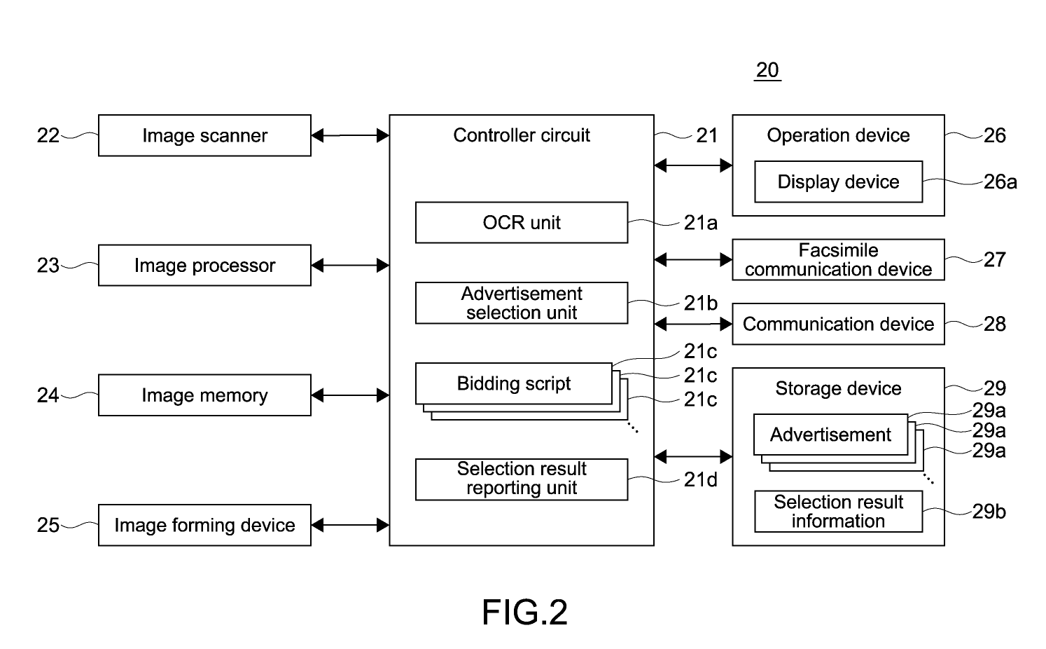

Next, a block configuration of the image forming apparatus 20 will be described. FIG. 2 schematically shows the block configuration of the image forming apparatus 20.

The image forming apparatus 20 includes a controller circuit 21. The controller circuit 21 includes a CPU (Central Processing Unit), a RAM (Random Access Memory), a ROM (Read Only Memory), dedicated hardware circuits, and the like and performs overall operational control of the image forming apparatus 20.

The controller circuit 21 is connected to an image scanner 22, an image processor 23, an image memory 24, an image forming device 25, an operation device 26, a display device 26a, a facsimile communication device 27, a communication device 28, a storage device 29, and the like. The controller circuit 21 performs operational control of the respective devices connected thereto and sends/receives signals and data to/from those devices.

According to job execution instructions input by a user via the operation device 26 or a PC connected to the network, the controller circuit 21 controls drive and process of mechanisms requisite for executing operational control of functions such as a scanner function, a printing function, a copy function, and a facsimile sending/receiving function.

Further, the controller circuit 21 includes an OCR (Optical Character Recognition) unit 21a, an advertisement selection unit 21b, bidding scripts 21c, and a selection result reporting unit 21d. The CPU of the image forming apparatus 20 loads a program, which is stored in a ROM or the like, in a RAM and executes the program. When the CPU of the image forming apparatus 20 executes the program, the CPU operates as the OCR unit 21a, the advertisement selection unit 21b, the bidding scripts 21c, and the selection result reporting unit 21d, which are functional blocks.

The OCR unit 21a executes an OCR process on image data read by the image scanner, and extracts character data.

When causing the display device 26a to display an advertisement 29a, the advertisement selection unit 21b sends the character data extracted by the OCR unit 21a to each bidding script 21c, causes the bidding scripts 21c to perform competitive bidding of an advertisement fee, and determines to cause the display device 26a to display the advertisement 29a of the bidding script 21c that bids the highest advertisement fee.

Further, the advertisement selection unit 21b stores, in the storage device 29, which advertisement 29a is displayed and how much the advertisement fee is, as selection result information 29b.

The bidding script 21c is a script (program) provided from each advertiser. The bidding script 21c analyzes the content of character data input from the OCR unit 21a, selects an advertisement to be displayed from a plurality of prepared advertisements, and determines an advertisement fee to be used for bidding when performing competitive bidding.

The selection result reporting unit 21d uploads the selection result information 29b stored in the storage device 29 to the head office server 10 periodically or at predetermined timing.

The image scanner 22 reads an image from a script.

The image processor 23 carries out an image process as necessary on image data of an image read by the image scanner 22. For example, the image processor 23 corrects shading of an image read by the image scanner 22 and carries out other image process to improve the quality of the image to be formed.

The image memory 24 includes an area that temporarily stores data of a script image read by the image scanner 22 or data to be printed by the image forming device 25.

The image forming device 25 forms an image of image data and the like read by the image scanner 22.

The operation device 26 includes a touch panel device and an operation key device that accept user's instructions on various operations and processes executable by the image forming apparatus 20. The touch panel device includes the display device 26a such as an LCD (Liquid Crystal Display) equipped with a touch panel.

The facsimile communication device 27 includes an encoding/decoding device, a modulation/demodulation device, and an NCU (Network Control Unit) (all of which are not shown) and transmits facsimiles using a public telephone network.

The communication device 28 is constituted of a communication module such as a LAN board and sends/receives various types of data to/from apparatuses such as the head office server 10 and the PC via a LAN connected to the communication device 28, and the like.

The storage device 29 stores a script image read by the image scanner 22, the advertisement 29a displayed on the display device 26a, the selection result information 29b, and the like. The storage device 29 is a large-volume storage device such as an HDD (Hard Disk Drive).

The configuration of the image forming apparatus 20 has been described heretofore. Note that since a general-purpose computer may be used as the head office server 10, detailed description of the configuration thereof will be omitted.

[Flow of Data]

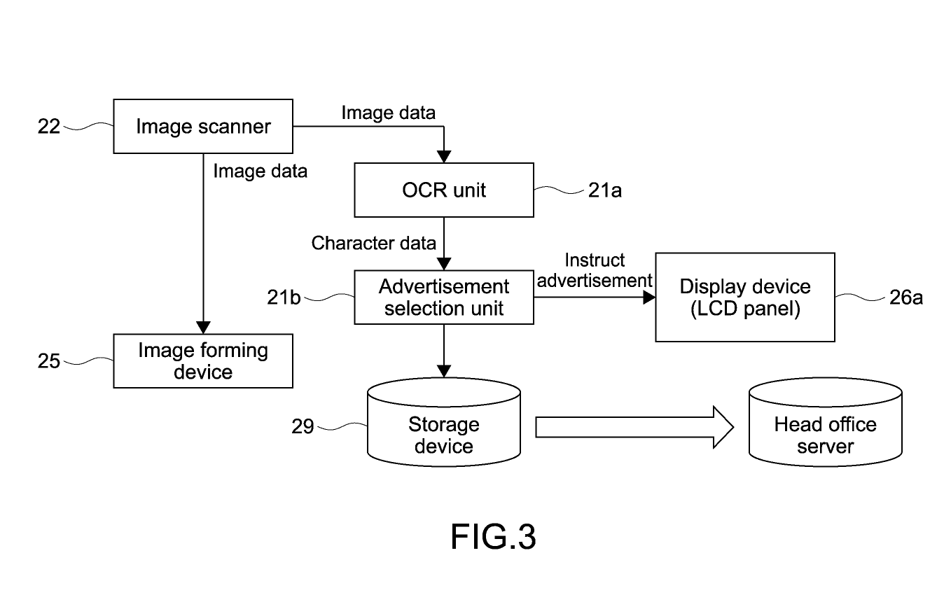

Next, flow of data in the information processing system 1 will be described. FIG. 3 shows flow of data in the information processing system 1.

The flow can be roughly divided into two. One is flow in which a user of the image forming apparatus 20 copies a script.

The image data read by the image scanner 22 is transmitted to the image forming device 25 and printed. By this flow, the user can copy the script. Note that although the process executed by the user is a copy process here, the process executed by the user may be a FAX transmission process or the like as long as it is a process of reading a script.

The other is flow of a process causing the display device 26a to display an advertisement by using the image data read by the image scanner 22.

The OCR unit 21a executes the OCR process on the image data read by the image scanner 22 and extracts character data, and the advertisement selection unit 21b causes the bidding scripts 21c to perform competitive bidding for a right to display an advertisement. The bidding script 21c that has bid the highest advertisement fee acquires a right to display an advertisement on the display device 26a, and the advertisement is displayed.

After the advertisement display, what the displayed advertisement is and the advertisement fee of the advertisement are stored in the storage device 29 as the selection result information 29b. The stored selection result information 29b is uploaded to the head office server 10 at predetermined timing. The advertisement fee summed up by the head office server 10 is charged to each advertiser.

Flow of data in the information processing system 1 has been described heretofore.

[Regarding Competitive Bidding]

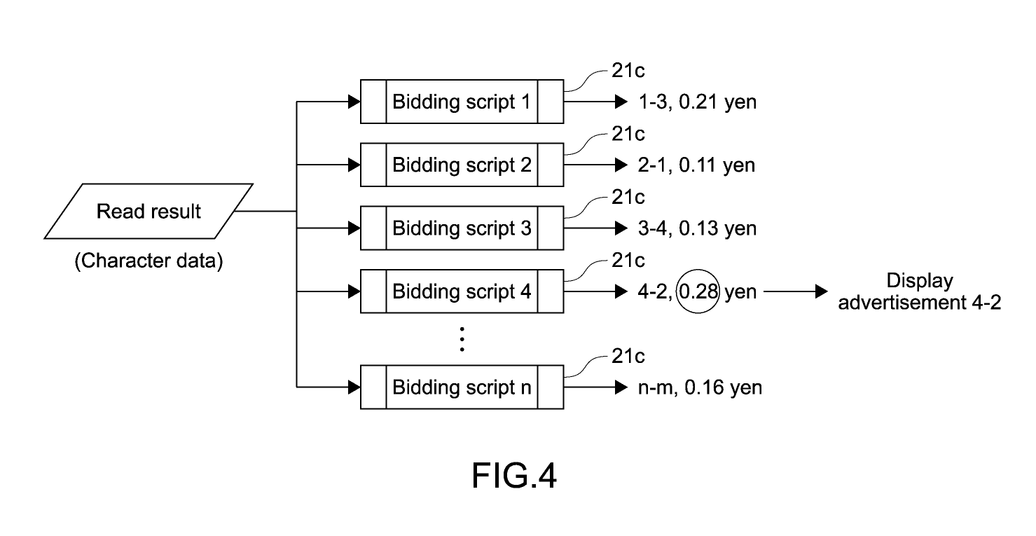

Next, an example of competitive bidding performed by the plurality of bidding scripts 21c will be described. FIG. 4 shows an example of competitive bidding performed by the plurality of bidding scripts 21c.

To each bidding script 21c, character data is input from the OCR unit 21a. Each bidding script 21c independently analyzes the character data, and determines selection of the advertisement to be displayed and the advertisement fee to be bid.

In the example shown in FIG. 4, an advertisement 1-3 (third advertisement provided by the advertiser 1) is desired to be displayed by a bidding script 1 provided from an advertiser 1, and 0.21 yen is presented as the advertisement fee.

Further, an advertisement n-m is desired to be displayed by a bidding script n provided from an advertiser n, and 0.16 yen is presented as the advertisement fee.

After completing the bidding of the advertisement fee from each bidding script 21c, the advertisement selection unit 21b provides a right to display an advertisement on the display device 26a to the bidding script 21c that has presented the highest advertisement fee.

In the example shown in FIG. 4, since a bidding script 4 of an advertise 4 presents the highest advertisement fee, 0.28 yen, the bidding script 4 makes a successful bid for the right to display the advertisement on the display device 26a, and an advertisement 4-2 is displayed.

An example of competitive bidding performed by the plurality of bidding scripts 21c has been described heretofore.

[Example of Bidding Script]

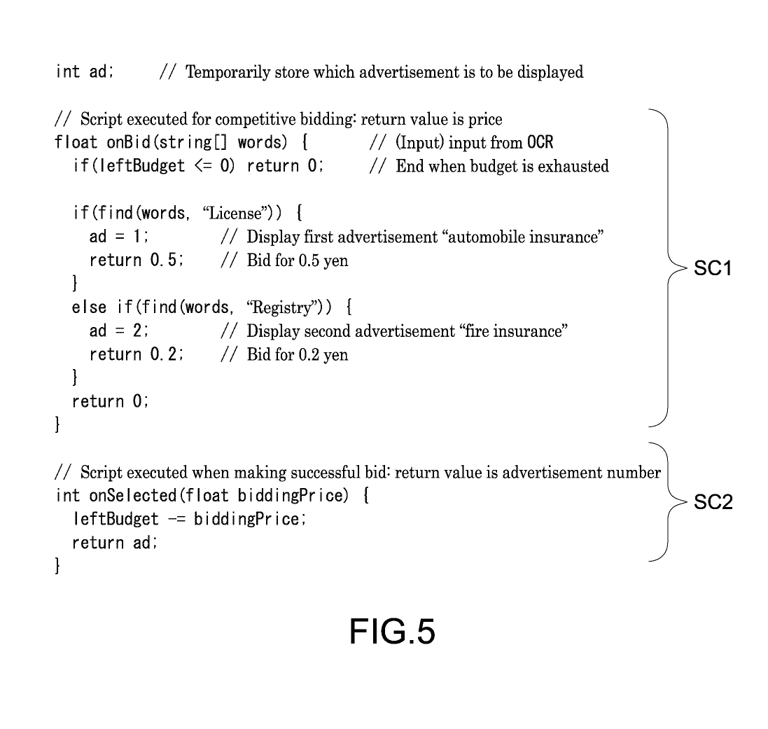

Next, an example of the bidding script 21c for performing competitive bidding, which is provided from each advertise, will be described. FIG. 5 shows an example of the bidding script 21c for performing competitive bidding, which is provided from each advertiser. Note that the language used in the example is not a specific language, and is used for convenience in order to exemplify the content of process.

An upper script SC1 is used for competitive bidding. In the case where character data input from the OCR unit 21a includes a character string of “license”, a first advertisement relating to automobile insurance is desired to be displayed by the script SC1, and 0.5 yen is presented as the advertisement fee.

Further, in the case where the character data input by the OCR unit 21a includes a character string of “registry”, a second advertisement relating to fire insurance is desired to be displayed by the script SC1, and 0.2 yen is presented as the advertisement fee.

Next, a lower script SC2 is a script executed in the case of making a successful bid for a right to display an advertisement, and the advertisement fee for this successful bid is subtracted from budget to be used for an advertisement. Then, in the case where the budget to be used for an advertisement (leftBudget) reaches 0 or minus, the bidding script SC1 stops bidding (returns 0 as a price for an advertisement to be bid).

Note that above-mentioned example is an example of the simplest bidding script 21c, and each advertiser may freely describe the content of process, e.g., the content of process is changed depending on the frequency of use of a phrase. Accordingly, the advertiser can display a more accurate target advertisement.

An example of the bidding script 21c for performing competitive bidding, which is provided from each advertise, has been described heretofore.

[Flowchart of a Process (part 1)]

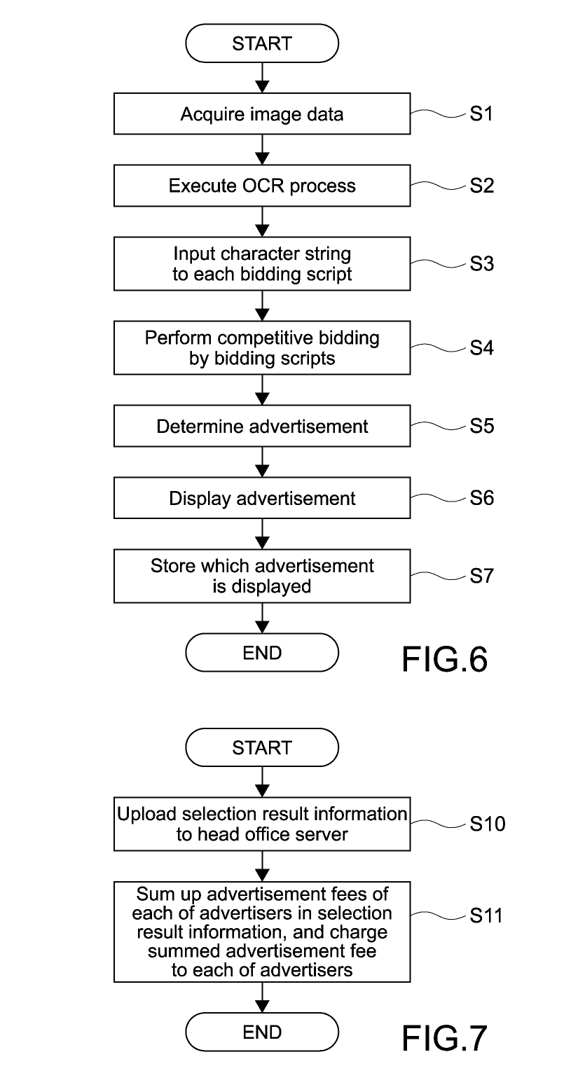

Next, flowchart of a process executed each time a user causes the image forming apparatus 20 to read a script among processes executed by the information processing system 1 will be described. FIG. 6 shows flowchart of a process executed each time a user causes the image forming apparatus 20 to read a script among the processes executed by the information processing system 1.

First, the OCR unit 21a acquires image data obtained by scanning performed by the image scanner 22 (Step S1).

Next, the OCR unit 21a executes the OCR process on the acquired image data, and extracts character data (step S2).

Next, the OCR unit 21a inputs the extracted character data to each bidding script 21c (Step S3).

Next, each bidding script 21c analyzes the received character data, presents an advertisement to be displayed and an advertisement fee, and performs competitive bidding (Step S4).

Next, the advertisement selection unit 21b determines the bidding script 21c that has presented the highest advertisement fee (Step S5).

Next, the advertisement selection unit 21b causes the display device 26a to display the advertisement to be displayed selected by the determined bidding script 21c (that has made a successful bid) (Step S6).

Next, the advertisement selection unit 21b stores, in the storage device 29, which advertisement is displayed and how much the advertisement fee is as the selection result information 29b (Step S7).

The flowchart of a process executed each time a user causes the image forming apparatus 20 to read a script among the processes executed by the information processing system 1 has been described heretofore.

[Flowchart of a Process (part 2)]

Next, flowchart of the process of a part relating to a process of charging an advertisement fee to the advertiser among the processes executed by the information processing system 1 will be described. FIG. 7 shows flowchart of the process of a part relating to the process of charging an advertisement fee to the advertiser among the processes executed by the information processing system 1.

First, the selection result reporting unit 21d uploads the selection result information 29b stored in the storage device 29 to the head office server 10 at predetermined timing (Step S10).

Next, the head office server 10 charges the advertisement fee to each advertiser based on the uploaded selection result information 29b (Step S11).

The flowchart of the process of a part relating to the process of charging an advertisement fee to the advertiser among the processes executed by the information processing system 1 has been described heretofore.

[Supplementary Note]

A liquid crystal panel is mounted on many recent apparatuses, and used for displaying an advertisement. Specific examples thereof include a POS (Point of Sales) terminal in a convenience store, an in-vehicle monitor for a commuter train, and the like. A liquid crystal panel is mounted on a multifunction machine or a copy machine, and it is expected that the liquid crystal panel is demanded to display an advertisement in the future.

However, in fact, since a multifunction machine installed in a convenience store or the like does not know a user's profile, it is difficult to display an appropriate advertisement suitable for the user.

Considering from the viewpoint of the advertiser, since the advertisement for persons who are not target customers are in vain, it is difficult to recruit an advertiser of high unit cost. As a result, only advertisements relating to products in the convenience store or service of the convenience store itself increase.

As described above, it is difficult to display an appropriate advertisement on a multifunction machine.

Note that in the case of the electronic advertisement, various efforts have been made to present an appropriate advertisement to the user depending on the content of a processing target such as a script to be copied and a Web page to be displayed.

For example, the content of an affiliate site and the content of advertisement content to be posted on the site are caused to match. Such technology that communication with an advertisement delivery computer is performed by using a keyword set based on the content of the affiliate site, and an appropriate advertisement is displayed is conceivable.

Further, for example, when a viewer sees an item of interest while viewing a program, the viewer starts a request for information (RFI) with respect to the item. When the RFI is input, a client apparatus such as a set-top box detects the RFI, and transmits, to a server, RFI data including the viewed channel, time stamp, and closed caption data. The RFI data is cross-referenced with program time code information, program guide information, program information, and/or advertisement information, and determines the context of the RFI, i.e., what the user has viewed. Such technology that information on the item that the user has viewed is transmitted to the viewer by a system message, an e-mail message, mail, or the like, is conceivable.

However, with these technologies, it is necessary to separately set up an independent server in order to select an appropriate advertisement and present the selected advertisement to a user.

Meanwhile, with the information processing system 1 according to the present disclosure, the head office server 10 sums up advertisement fees of advertisements displayed on each of the image forming apparatuses 20, and charges a summed advertisement fee to each of the advertisers. Each image forming apparatus 20 displays an advertisement on a display device on an operation panel, corresponding to the content of a script copied by a user. Note that the point to be noted with the above-mentioned configuration is that the head office server 10 is used for executing the process of collectively charging advertisement fees to advertisers, and is not related at all to selection and display of an advertisement. A process of selecting an advertisement and a process of displaying an advertisement are independently executed by each image forming apparatus 20.

Therefore, it is possible to display an advertisement corresponding to the content of a processing target without setting up an independent server for displaying an advertisement.

It should be understood by those skilled in the art that various modifications, combinations, sub-combinations and alterations may occur depending on design requirements and other factors insofar as they are within the scope of the appended claims or the equivalents thereof.

What is claimed is:

1. An information processing system comprising:
information processing apparatuses installed in one or more shop sites; and
a head office server connected to each of the information processing apparatuses via a network, the head office server being installed in a head office site,
each of the information processing apparatuses including:
a communication device that communicates with the head office server;
an operation device;
a display device;
a storage device that stores one or more advertisements that can be displayed on the display device;
an image scanner that reads a script and generates image data;
a ROM that stores an information processing program; and
a processor that executes the information processing program, wherein
the processor executes the information processing program to function as
an OCR processing unit that executes an OCR process on the image data generated by the image scanner, and extracts character data,
one or more bidding scripts that (i) analyze the character data transmitted from the OCR processing unit, (ii) select, on the basis of an analysis result, an advertisement to be displayed on the display device from the one or more advertisements, and (iii) present an advertisement fee for the selected advertisement to participate in competitive bidding, and
an advertisement selection unit that (i) selects, on the basis of a result of the competitive bidding, a bidding script that has presented a highest advertisement fee, (ii) causes the display device to display an advertisement to be displayed selected by the selected bidding script, and (iii) stores selection result information in the storage unit, the selection result information including a result of the selection and the advertisement fee that the selected bidding script has presented.

2. The information processing system according to claim 1, wherein
the processor executes the information processing program to further function as a selection result reporting unit that uploads, at predetermined timing, to the head office server, the selection result information stored in the storage device.

3. The information processing system according to claim 2, wherein
each of the one or more bidding scripts is provided from respective advertisers.

4. The information processing system according to claim 3, wherein
each of the one or more bidding scripts stops, in a case where there is no budget to be used for an advertisement, participating in the competitive bidding.

5. The information processing system according to claim 4, wherein
each of the one or more bidding scripts subtracts, in a case of making a successful bid for a right to display an advertisement, the advertisement fee for this successful bid from the budget to be used for an advertisement, and stops participating in the competitive bidding in a case where the budget to be used for an advertisement reaches 0 or minus.

6. The information processing system according to claim 2, wherein
the head office server sums up advertisement fees of each of the advertisers in the selection result information uploaded by the information processing apparatuses, and charges a summed advertisement fee to each of the advertisers.

7. An information processing method for an information processing system including information processing apparatuses installed in one or more shop sites and a head office server connected to each of the information processing apparatuses via a network, the head office server being installed in a head office site, the method comprising:
via each of the information processing apparatus,
reading, by an image scanner, a script;
generating, by the image scanner, image data;
executing an OCR process on the image data generated by the image scanner;
extracting character data;
analyzing the character data;
selecting, on the basis of an analysis result, an advertisement to be displayed from one or more advertisements;
presenting an advertisement fee for the selected advertisement;
participating in competitive bidding;
selecting, on the basis of a result of the competitive bidding, a bidding script that has presented a highest advertisement fee;
causing to display an advertisement to be displayed selected by the selected bidding script; and
storing selection result information, the selection result information including a result of the selection and the advertisement fee that the selected bidding script has presented.
